(19) United States
(12) Patent Application Publication
(10) Pub. No.: US 2006/0157461 A1
(43) Pub. Date: Jul. 20, 2006

(54) Welding wire spool and drive cartridge

(75) Inventors: Craig L. Diekmann, Mentor, OH (US); Bryan J. Nelson, Chardon, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Lincoln Global, Inc.

(21) Appl. No.: 11/039,242

(22) Filed: Jan. 20, 2005

(51) Int. Cl. B23K 9/10

(52) U.S. Cl. 219/137.71; 219/137.2

(57) ABSTRACT

A modular welding wire cartridge for use in a welding system. The welding wire cartridge is designed to be detachably connected to the welding wire feed system of the welding system. The welding wire cartridge includes a drive housing designed to be detachably connectable to the welding wire feed system, a wire contact arrangement designed to controllably feed welding wire through the welding wire cartridge, and a spool of welding wire.

The present invention is related to the art of welding and more particularly to welders that include the use of wire feeders and even more particularly to welding wire sources for wire feeders.

### BACKGROUND OF THE INVENTION

Wire feeders for electric arc welders typically include a welding wire drive assembly that pulls welding wire from a welding wire source (e.g., wire spool, canister of wire, etc.) and then feeds the welding wire to the welding gun. The wire drive assembly typically includes one or more drive wheels that pull and push the welding wire at a desired or controlled wire feed speed so that the proper amount of molten metal is deposited on a workpiece during the formation of a weld bead or the like.

The wire feeder for many types of welding operations is either connected to or integrated with the welder. The wire feeder includes an integrated motor, drive rollers, gears, and wire guides designed to draw the welding wire from a welding wire source and then push the welding wire through a welding cable and through the welding gun. The length of the welding cable is typically several feet long (e.g., 10-50 ft.). As such, more rigid welding wire (e.g., carbon steel based wire, stainless steel based wire, titanium wire, nickel based wire, etc.) is used in such configurations.

When the source of welding wire is used up during use of the welding unit, an operator is required to change out the used-up source of welding wire and replace it with a new source of welding wire. The changing out of the new source of welding wire can be time consuming since the welding wire must be properly threaded during the drive rollers of the wire feeder, and the tension on the welding wire must be properly set or the welding wire will not be properly fed by the wire feeder. A welding wire source may also have to be changed with another source when a different type of welding operation is to be performed. Welding units are commonly designed to perform a number of different welding operations. Some of the these different welding operations require certain types of welding electrodes (e.g., wire diameter, wire composition, etc.). In addition, different types of workpieces can require different types of welding wire to form the proper weld bed for the particular workpiece. As a result, the welding wire must be changed out for use on different types of worpieces. This repeated changing out of the welding wire is time consuming and can increase the wear on the drive rollers of the wire feeder. In addition, the repeated tension adjustments required on the drive rollers to properly feed the welding wire through the wire feeder is also time consuming and can result in misalignment and/or damage to the drive rollers over time. The improper selection of welding wire for a particular welding operation can also result in an improper welding bead being formed on a particular workpiece.

In view of the state of the prior art with respect to wire feeders and welding wire sources for wire feeders, there is a need for a wire feed arrangement that simplifies the changing out and/or selection of welding wire sources for a wire feeder.

### SUMMARY OF THE INVENTION

The present invention is directed to an interchangeable welding wire cartridge for use in a welding system such as, but not limited to, an electric arc welding system. In accordance with one aspect of the present invention, the welding wire cartridge can be designed to be a) detachably connected to a wire feeder that is integrated in a welding unit, b) detachably connected to a separate wire feeder that is used in conjunction with a welding unit, and/or c) detachably connected to a wire feeder that is on or integrated with a welding gun. The welding wire cartridge is a versatile arrangement that enables a user to easily and quickly change out a source of welding wire on a wire feeder for use in a particular welding operation. As such, the welding wire cartridge enables a user to replace a depleted welding wire source with another source of welding wire in a quick, easy and/or efficient manner. In addition, the welding wire cartridge enables a user to switch out one type of welding wire source for another for use in a particular welding operation in a quick, easy and/or efficient manner.

In accordance with another and/or alternative aspect of the present invention, the welding wire cartridge includes a cartridge housing designed to be detachably connectable to a wire feeder system. The cartridge housing is typically formed of a durable material (e.g., metal, plastic, reenforced polymers, etc.) so as to withstand the typical environment of a welding system and/or to protect one or more components contained within the cartridge housing. The cartridge housing is configured so that it can be connected to a cartridge housing interface on 1) a stand alone wire feeder and/or a wire feeder integrated in a welder unit, and/or 2) a welding gun and/or wire feeder system integrated with a welding gun. The configuration of the cartridge housing is selected to facilitate in the ease and convenience of connecting and disconnecting the cartridge housing from the cartridge housing interface on the wire feeder. The cartridge housing can include one or more connectors (e.g., tabs, latches, clips, quick-connect, etc.) that facilitate in releasably securing the cartridge housing to the cartridge housing interface on the wire feeder.

In accordance with still another and/or alternative aspect of the present invention, the welding wire cartridge includes a wire contact arrangement designed to contact the welding wire and to drive the welding wire at least partially through the welding wire cartridge. In one non-limiting embodiment, the wire contact arrangement includes at least one drive roller. As can be appreciated, other and/or additional configurations can be used. The drive roller can include one or more rough surfaces to facilitate in the gripping of the welding wire so as to reduce slippage of the welding wire. When two drive rollers are used, the drive rollers can be positioned adjacent to one another and rotated in opposite directions to drive the welding wire between the drive rollers. One or both of the drive rollers can include a groove used to guide and maintain the welding wire between the drive rollers as the drive rollers move the welding wire through the welding wire cartridge. As can be appreciated other and/or additional arrangements for the wire contact arrangement can be used. The tension of the wire contact arrangement on the welding wire can be fixed or adjustable. In one non-limiting design, the tension of the wire contact arrangement on the welding wire is preset and fixed so as to ensure that the proper wire tension is applied to the welding wire. The proper tension on the welding wire facilitates in ensuring that the wire contact arrangement properly engages and drives the weld wire, thus reducing or preventing incidences of wire slippage which can adversely affect the feed rate of the welding wire. If the tension is adjustable, the cartridge housing can be designed to enable a user to open and/or access the wire contact arrangement in the cartridge housing, and/or include an adjustment knob, screw, button, etc., that enables a user to adjust the tension on the welding wire without having to open and/or access the interior region of the cartridge housing. In one non-limiting design, the cartridge housing does not allow easy access to the one or more components in the cartridge housing. As such, if any adjustment arrangements are provided on the cartridge housing, which are not required, the adjustment arrangements are accessible from or exposed to the exterior surface of the cartridge housing. In one non-limiting design, the interior of the cartridge housing is not easily accessible and no adjustments are provided. In such a design, the welding wire cartridge is a disposable device designed to be thrown away after the welding wire is fully expended in the cartridge housing. The wire contact arrangement can be partially or fully contained in the cartridge housing.

In accordance with still yet another and/or alternative aspect of the present invention, the welding wire cartridge can include a gear arrangement used to at least partially interconnect the one or more drive motors to the wire contact arrangement. The one or more motors are typically positioned on the wire feeder (e.g., part of the cartridge housing interface, positioned in the wire feeder, etc.); however, this is not required. The gear arrangement can include one or more gears. When the wire contact arrangement includes two drive rollers, the gear arrangement can be used to at least partially cause the two drive rollers to rotate at a desired speed with respect to one another. The gear arrangement can be partially or fully contained in the cartridge housing.

In accordance with still yet another and/or alternative aspect of the present invention, the welding wire cartridge can include one or more wire guides designed to at least partially guide the welding wire within the cartridge housing. In one non-limiting arrangement, there is provided a wire guide that at least partially guides the welding wire from the wire contact arrangement to an exterior of the cartridge housing. The wire guide is typically designed to facilitate in the guiding of the welding wire through an opening in the cartridge housing and/or to reduce the incidence of the welding wire kinking or bending as the welding wire is pushed from the wire contact arrangement. In another and/or alternative non-limiting arrangement, there is provided a wire guide that at least partially guides the welding wire as the welding wire is fed to the wire contact arrangement. The wire guide is typically designed to facilitate in the guiding of the welding wire from a welding wire source within the cartridge housing, and/or to reduce the incidence of the welding wire kinking or bending as the welding wire is fed to the wire contact arrangement. In one non-limiting design of the wire guide, the wire guide includes a cylindrically shaped passageway that has an inner diameter that is a little larger than the diameter of the welding wire so as to allow the welding wire to pass through the cylindrically shaped passageway while inhibiting or prevent the welding wire from kinking as it passes through the cylindrically shaped passageway. As can be appreciated, other and/or additional designs of the wire guide can be used. The one or more wire guides can be partially or fully contained in the cartridge housing.

In accordance with a further and/or alternative aspect of the present invention, the welding wire cartridge can include a cartridge housing that includes a wire spool compartment or region designed to contain a spool of welding wire. The wire spool compartment can include a spool mount designed to support the wire spool in a certain position in the wire spool compartment and to enable the wire spool to rotate as the welding wire is unwound from the wire spool. In one non-limiting arrangement, the cartridge housing can be opened, and/or include an opening and/or openable access to the wire spool compartment to enable the wire spool to be replaced. In another non-limiting arrangement, the cartridge housing is designed so that a user cannot easily access the interior of the cartridge housing or open the cartridge housing, thus the user is not able to replace the spool of wire in the cartridge housing. As such, the wire feed cartridge is designed to be disposable after the welding wire on the wire spool has been depleted. The cartridge housing can be designed such that the wire spool is fully or partially contained in the cartridge housing. In another and/or alternative non-limiting arrangement, a wire spool tension arrangement is provided to at least partially provide tension on the wire spool in the wire spool compartment. When the wire spool is freely rotatable, the welding wire on the wire spool can partially unravel or unwind from the wire spool, thereby resulting in entanglement of the welding wire and/or kinking of the welding wire. The wire spool tension arrangement inhibits or prevents the wire spool from freely rotating, thereby maintaining tension on the welding wire as the welding wire is fed through the welding wire cartridge. The tension on the wire spool inhibits or prevents undesired unwinding or unraveling of the welding wire from the wire spool. The wire spool tension arrangement can provide an adjustable or fixed tension to the wire spool. The wire spool tension arrangement can be partially or fully contained in the cartridge housing. In still another and/or alternative non-limiting arrangement, the wire spool is positioned in the cartridge housing relative to the wire contact arrangement so as to facilitate in the proper feeding of the welding wire from the wire feed cartridge. In one non-limiting design, the maximum angle that the welding wire is fed to the wire contact arrangement from the wire spool relative to a feed axis is less than about 50°, and typically less than about 45°. The feed axis is defined as the axis at which the wire is fed through the wire contact arrangement. As such, when the wire contact arrangement includes two drive rollers, the feed axis is along the plane that divides the two drive rollers. When the angle of the welding wire from the wire spool relative to the feed axis is too great, the incidence of wire slippage through the wire contact arrangement can increase and/or the desired welding wire feed rates cannot be properly maintained. In another and/or alternative non-limiting design, the wire spool is oriented in the spool compartment of the cartridge housing such that when the wire spool is about half depleted, the angle that the welding wire is fed to the wire contact arrangement from the wire spool relative to a feed axis is about 0-20°, and typically about 0-15°, and even more typically about 0-10°.

In accordance with still a further and/or alternative aspect of the present invention, the welding wire feed drive can include a cartridge housing that has a front wire opening. When the welding wire cartridge is used on a welding gun, the front wire opening can be designed to be connected to the front portion or barrel of the welding gun. The front opening enables the welding wire to pass through the barrel of the gun and then through the tip of the welding gun. When the welding wire cartridge is used in a wire feeder, the front opening can be designed to be connected to a welding cable that feeds the welding wire to a welding gun. The connection arrangement for the welding cable and/or component of a welding gun can be a threaded connection or some other or additional connection that enables an operator to detachably connect such components to the welding wire cartridge.

In accordance with yet a further and/or alternative aspect of the present invention, the welding wire cartridge can include an identification arrangement that provides information about the welding wire cartridge. Many types of information can be provided by the identification arrangement. Such information can include, but is not limited to, the type of welding wire included in the cartridge housing, the diameter of welding wire in the cartridge housing, the gear ratio of the gear arrangement in the cartridge, the wire tension and/or recommended tension associated with the wire contact arrangement, the current and/or recommended spool break tension, the set and/or recommended welding wire feed speed, the amount of welding wire remaining on the wire spool, model information about the welding wire cartridge, parts information regarding the welding wire cartridge, information about when and/or in what welding unit the welding wire cartridge can be used, voltage information for the welding power wave, current information for the welding power wave, welding wire polarity information for the welding power wave and/or shielding gas information. The identification arrangement can provide information to the welding system (e.g., welding unit, welding gun, stand alone wire feeder unit used in conjunction with a welding unit, wire feeder integrated in a welding unit, etc.) mechanically (e.g., one or more ridges and/or indents that contact a surface that detects the ridges and/or indents, etc.), visually (e.g., bar code, etc.), electromagnetically (e.g., radio waves, infrared light, lasers, etc.) and/or electronically (e.g., information chip, electrical circuit, certain pattern of electrical contacts, etc.). As can be appreciated, many different arrangements can be used to convey information about the welding wire cartridge to the welding system. In one non-limiting arrangement, at least a portion of the identification arrangement is located on the exterior surface of the cartridge housing so as to facilitate in the transfer of information between the welding wire cartridge and the welding system; however, this is not required.

In accordance with still yet a further and/or alternative aspect of the present invention, the welding wire cartridge can include a control interface that provides information between the welding wire cartridge and the welding system (e.g., welding unit, welding gun, stand alone wire feeder unit used in conjunction with a welding unit, wire feeder integrated in a welding unit, etc.). This information can include, but is not limited to, control information to control the operation of the welding wire cartridge (e.g., adjust welding wire tension, adjust wire spool tension, change gearing of gear arrangement, etc.) and/or the information can include current operating conditions of the welding wire cartridge (e.g., wire feed speed, amount of welding wire remaining on wire spool, welding wire tension, wire spool tension, etc.). The control interface can transfer such information electronically (e.g., via electrical contacts); however; the information can alternatively or additionally be transferred by various types of electromagnetic waves (e.g., radio waves, infrared light, lasers, etc.) and/or other and/or additional means. In one non-limiting arrangement, at least a portion of the control interface is located on the exterior surface of the cartridge housing so as to facilitate the transfer of information between the welding wire cartridge and the welding system; however, this is not required. When a control interface and an identification arrangement are included with the welding wire cartridge, the control interface and the identification arrangement can be integrated together; however, this is not required.

In accordance with another and/or alternative aspect of the present invention, the welding wire cartridge can include a visual identifier to enable a user to easily and/or conveniently identify at least one characteristic of the welding wire cartridge. In one non-limiting arrangement, the visual identifier includes one or more colors on the welding wire cartridge and/or packaging for the welding wire cartridge. The color coding on the welding wire cartridge and/or packaging for the welding wire cartridge can be representative of the type of welding unit the welding wire cartridge can be used in and/or the type of welding wire that is to be used with and/or contained in the welding wire cartridge. As can be appreciated, the color coding can be representative of other and/or additional characteristics of the welding wire cartridge (e.g., diameter of the welding wire in the welding wire cartridge, amount of welding wire in the welding wire cartridge, shielding gas to be used with the welding wire in the welding wire cartridge, type of wire feeder that can be used with the welding wire cartridge, type of welding gun that can be used with the welding wire cartridge, the type of welding operations recommended for use with the welding wire cartridge, etc.). As can also be appreciated, other and/or additional visual identifiers (e.g., model numbers, model names, etc.) can be used on the welding wire cartridge and/or packaging for the welding wire cartridge to provide a user with easy and/or convenient information about at least one characteristic of the welding wire cartridge.

One object of the present invention is to provide an interchangeable and/or modular welding wire cartridge for use in a welding system.

Another and/or alternative object of the present invention is the provision of a welding wire cartridge that can be detachably connected to a wire feeder system.

Still another and/or alternative object of the present invention is the provision of a welding wire cartridge that includes a cartridge housing, a wire contact arrangement, a wire spool compartment, and/or a spool of welding wire.

Yet another and/or alternative object of the present invention is the provision of a welding wire cartridge that can include an identification arrangement that provides information about the welding wire cartridge.

Still yet another and/or alternative object of the present invention is the provision of a welding wire cartridge that can include a control interface that provides information between the welding wire cartridge and the welding system.

A further and/or alternative object of the present invention is the provision of a welding wire cartridge that can include a visual identifier to enable a user to easily and/or conveniently identify at least one characteristic of the welding wire cartridge.

These and other objects and advantages of the invention will become apparent to those skilled in the art upon reading and following this description taken together with the accompanying drawings.

### BRIEF DESCRIPTION OF THE DRAWINGS

Reference may now be made to the drawings which illustrate various embodiments that the invention may take in physical form and certain parts and arrangements of parts wherein:

FIG. 1 is a perspective view of a prior art wire feeder that feeds welding wire into a welding gun;

FIG. 2 is a front elevation view of a detachable welding wire cartridge in accordance with the present invention;

FIG. 3 is a front elevation view of a detachable welding wire cartridge inserted in a wire feeder;

FIG. 4 is a cross-section view of the detachable welding wire cartridge;

FIG. 5 is a cross-sectional view along lines 5-5 of FIG. 4; and,

FIG. 6 is a cross-sectional view along lines 6-6 of FIG. 4.

### DESCRIPTION OF THE PREFERRED EMBODIMENT

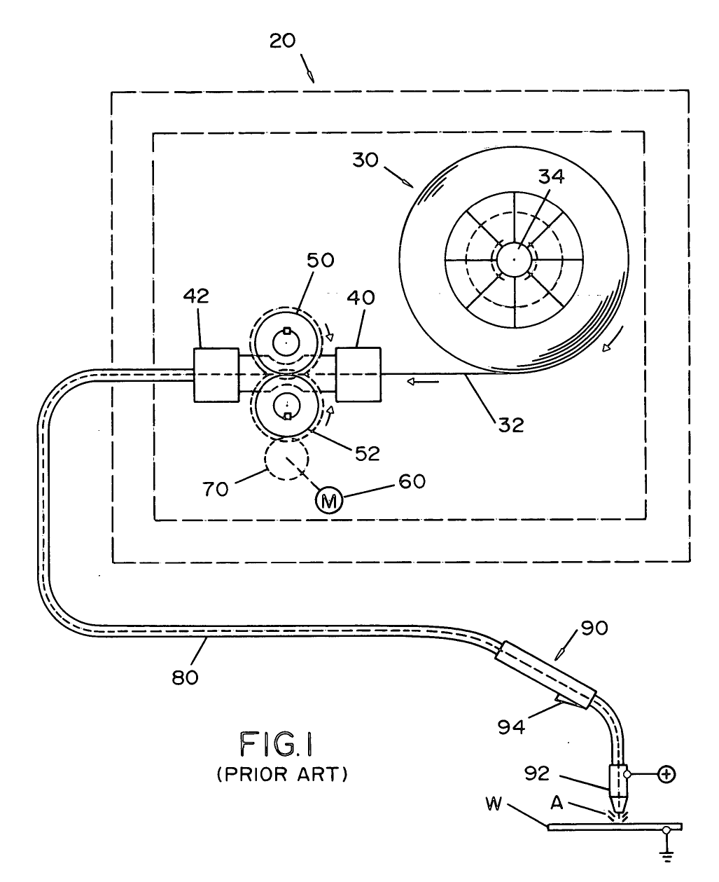

Referring now to the drawings, wherein the showings are for the purposes of illustrating the preferred embodiments of the invention only and not for the purpose of limiting the same, FIG. 1 illustrates a prior art wire feeder 20. Prior art wire feeder 20 is representative of a wire feeder integrated in a welding unit, not shown, such as, but not limited to, the Power MIG 225 offered by The Lincoln Electric Company, or a stand alone wire feeder that is used in conjunction with a welding unit, not shown, such as, but not limited to, the LF-72 Wire Feeder offered by The Lincoln Electric Company; however, the wire feeder is not limited to these two models of welding units or stand alone wire feeders.

Stand alone or integrated wire feeder 20 includes a reel or spool 30 of welding wire 32 rotatably positioned on a spindle 34. The welding wire 32 is fed into a wire guide 40 that directs the welding wire to drive rollers 50, 52. A motor 60 causes the drive rollers to rotate in opposite directions by the use of a gear arrangement 70. The rotation of the drive rollers causes the welding wire to be drawn from reel 30 at a controlled rate and to push the welding wire through a second wire guide 42. The welding wire continues to be pushed by the drive rollers into a welding cable 80 that is connected to the wire feeder. The welding wire passes through the welding cable and into a welding gun 90, and then through the tip 92 of the welding gun to be deposited in molten form on workpiece W. An electric arc A is used to melt the advancing welding wire. The welding gun includes a trigger 94 to send a signal to the wire feeder and/or welding unit to control the operation of motor 60.

When welding wire 32 is depleted from reel 30 and/or a new type of welding wire is required for a particular welding operation, the user is required to remove reel 30 from spindle 34 and disengage the welding wire from drive rollers 50, 52. Thereafter, a different reel of welding wire is inserted on the spindle and the welding wire is fed through the drive rollers. After the welding wire has been fed through the drive rollers, the tension on the welding wire by the drive roller must be adjusted to reduce the occurrence of wire slippage in the drive rollers. Additionally, the tension on the reel must be adjusted to inhibit or prevent the welding wire from inadvertently unraveling from the reel. The adjustment of the tension on the drive rollers and the reel is time consuming and/or can increase incidence of damage to the drive rollers and/or tension arrangements, and/or cause the drive rollers and/or reel to become misaligned, etc.

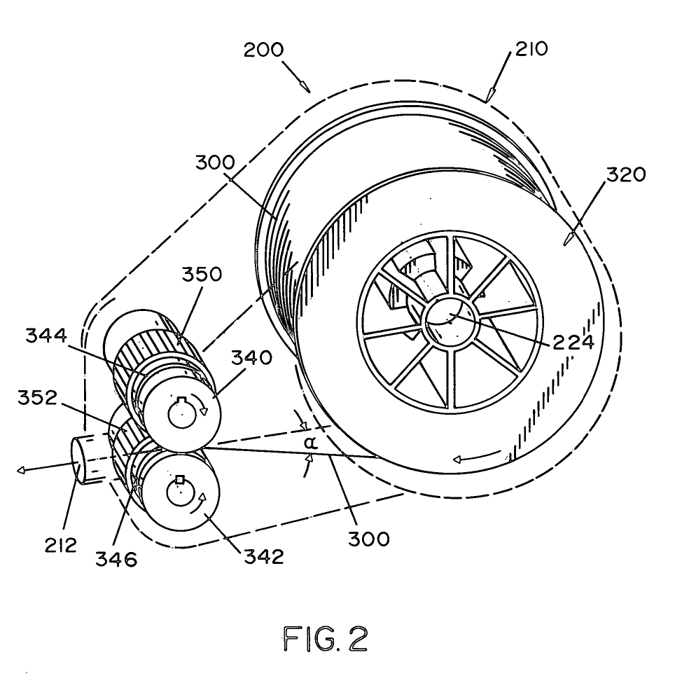

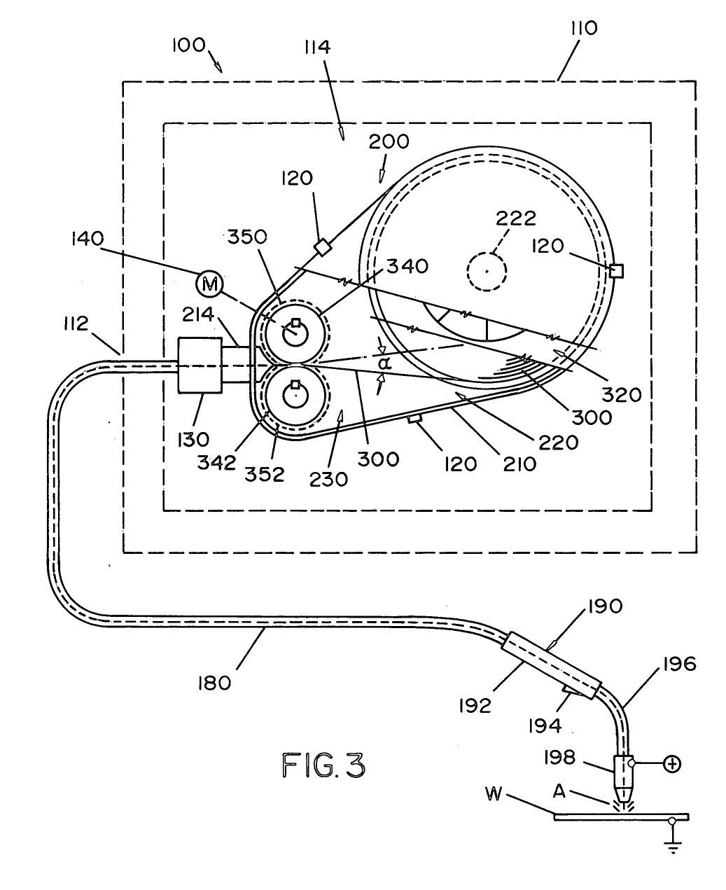

Referring now to FIG. 2, there is illustrated a welding wire cartridge 200. The welding wire cartridge is designed to be detachably connected to a wire feeder arrangement such as, but not limited to, a wire feeder arrangement of a stand alone wire feeder, a wire feeder that is integrated in a welding unit and/or a wire feeder on a spool gun. As illustrated in FIG. 3, a stand alone wire feeder 100 includes welding wire cartridge 200. The wire feeder 100 includes a housing 110. Connected to the wire feeder is a welding cable 180. One end of the welding cable is positioned in front opening 112 of housing 110. The other end of the welding cable is connected to welding gun 190. The welding gun includes a body 192 and a trigger 194 to control the advancement of welding wire through the welding gun. The welding gun also includes a barrel 196 that is connected at one end to body 192 and at the other end to welding tip 198. Positioned inside a side cavity 114 of the housing 110 of the wire feeder is a welding wire cartridge 200 that is detachably connected to a cartridge mount interface that is positioned in the side cavity of the housing. The cartridge mount interface includes three release clips 120 that are illustrated as releasably securing the welding wire cartridge to the cartridge mount interface. The cartridge mount interface has a shape that enables the welding wire cartridge to be easily connected and disconnected from the wire feeder. The cartridge mount can have a shape that only allows the welding wire cartridge to be oriented and connected in a certain manner to ensure that the welding wire cartridge has been properly connected to the wire feeder. The side cavity of housing 110 includes a wire guide 130 that guides the welding wire from the welding wire cartridge to welding cable 180. The wire guide also includes a connector arrangement to secure the welding cable to the wire feeder. As such, the welding current and/or control signals between the wire feeder and welding gun can be sent via the wire guide 130 and welding cable. The connector arrangement can be a number of different types of connectors (e.g., threaded connection, clamp connection, quick-release connector, etc.) to facilitate in securing the end of the welding cable to the wire guide. The wire feeder also includes a motor 140 that is used to rotate drive rollers in the cartridge housing of the welding wire cartridge, as will be described in more detail below. The welding wire cartridge, when connected to the cartridge interface of housing 110, is designed to push welding wire through welding cable 180 and into and through welding gun 190.

Referring now to FIGS. 2-4, welding wire cartridge 200 includes a housing 210 that has a front opening 212. The front opening enables welding wire 300 to exit the cartridge housing. The front opening is illustrated as being an opening in a front plug 214. The front plug can be used to at least partially seal the interior of the cartridge housing, thereby protecting the internal components (e.g., welding wire, etc.) from moisture, gasses, dirt etc. The front plug can be formed of a variety of materials (e.g., plastic, rubber, cork, etc.). When the welding wire cartridge is packaged, opening 212 can be covered with tape or another material to cover the opening until the welding wire cartridge is ready for use.

The housing 210 of the welding wire cartridge includes two principle compartments, namely, 1) a wire spool compartment 220 and 2) a drive roller compartment 230. The wire spool compartment is adapted to rotatably secure a spool 320 of welding wire 300. A central mount 222 can be used to rotatably mount the spindle of the wire spool in the wire spool compartment. The wire spool typically maintains its tension to inhibit or prevent the welding wire from uncontrollably unraveling from the wire spool. The amount of tension applied to the wire spool is typically fixed, thus no adjustment by the user is required. The tension mechanism can be part of the central mount 222 or be provided by another or additional arrangement. As illustrated in FIG. 5, the tension arrangement 224 is connected to the central mount and engages an inner surface of the wire spool to create a friction engagement. As can be appreciated, many other and/or additional arrangements can be used to form the tension arrangement.

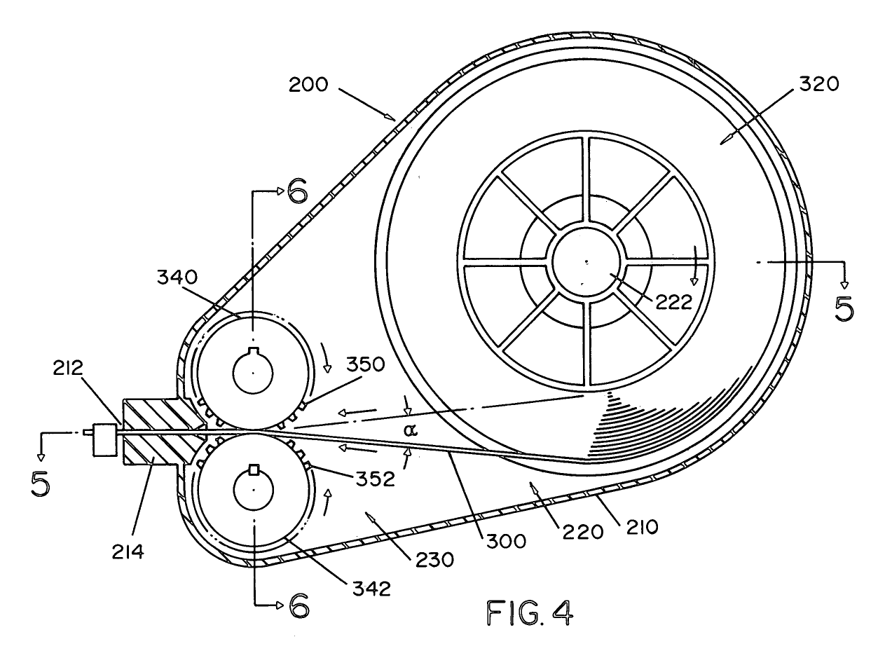

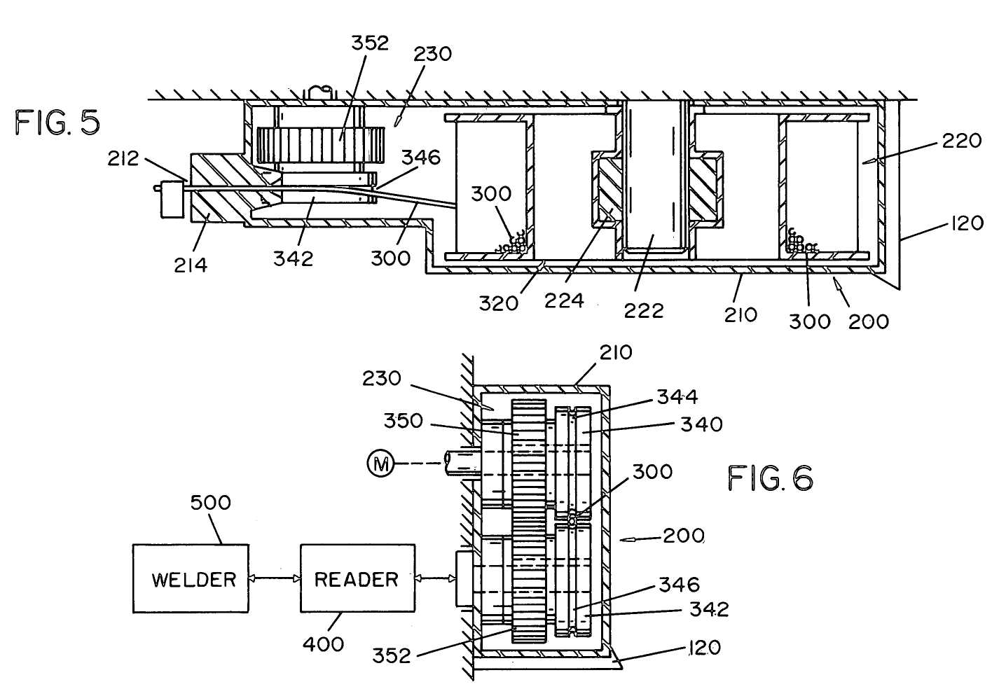

The welding wire 300 from the wire spool is adapted to move from the wire spool compartment 220 to drive roller compartment 230. Drive roller compartment 230 includes two drive rollers 340, 342. As can be appreciated, a greater or lesser number of drive rollers can be used. The drive rollers are positioned adjacent to one another such that the welding wire passes between the drive rollers. As illustrated in FIGS. 2 and 4, the wire spool is positioned in the wire spool compartment such that the welding wire fed from the wire spool has a maximum feed angle α relative to the feed axis (as indicated by a dotted line) from the drive roller of less than about 50°, and typically less than about 30°. The drive rollers can each include a guide groove 344, 346 as illustrated in FIG. 6 to facilitate in the feeding of the welding wire between the drive rollers when the drive rollers are rotating. The drive rollers are connected to a gear arrangement that includes gears 350, 352. As can be appreciated, many types of gear arrangements can be used which include the same, less or more gears. The gear arrangement is designed to cause the two drive rollers to rotate in opposite directions. The gear arrangement is also designed to rotate the two drive rollers at a proper speed relative to one another to achieve the desired welding wire feed rate. Typically when the drive rollers are the same size, the gear arrangement rotates the drive rollers at substantially the same speed; however, when the drive rollers are a different size, the speed of rotation of the two drive rollers may be different. As illustrated in FIG. 6, the gears of the gear arrangement are located in the drive roller compartment. As can be appreciated, the gears can be positioned in other ways. Gear 350 is illustrated as being connected to motor 140 which is external to the welding wire cartridge. Many arrangements can be used to engage one or more gears of the gear arrangement to motor 140. The arrangement for engagement of one or more gears with motor 140 is designed to simply engage the gears when the welding wire cartridge is releasably connected to the cartridge housing in the cavity of housing 100, and to simply disengage the gears when the welding wire cartridge is removed from the cavity of housing 100.

Referring again to FIG. 3, the welding gun includes a trigger 194 that is activated by a user to control the advancement of the welding wire by the wire feeder. A control cable or wire, not shown, is connected between the welding gun and the wire feeder via the welding cable 180. As the welding wire is advanced by the wire feeder, the welding wire is pushed through the welding gun and out from welding tip 198. An electric arc A melts a portion of the welding wire and the molten metal is deposited on workpiece W. The welding cable is designed to provide power from the wire feeder to the welding gun to generate electric arc A.

Referring now to FIG. 6, the welding wire cartridge can include an interface that is used to send and/or receive information between a reader 400. The reader can be part of the cartridge housing interface on housing 110. The information sent and/or received can be information to control and/or monitor one or more components of the welding system. As shown in FIG. 6, the information transferred to and/or from the reader 400 is monitored and/or received by a welder 500 that is connected to the wire feeder and/or integrated with the wire feeder. The welding in turn can be designed to send and/or receive information to the reader. The reader can obtain information mechanically, electrically, electromagnetically, etc.

Referring now to FIG. 2, the housing of the welding wire cartridge can include one or more visual identifiers 400 that can be used to provide information about one or more characteristics of the welding wire feed drive. The cartridge housing can include one or more transparent and/or semi-transparent regions to enable a user to view inside the cartridge housing to obtain information about the welding wire cartridge (e.g., amount of welding wire remaining on the spool, etc.).

The invention has been described with reference to a preferred embodiment and alternates thereof. It is believed that many modifications and alterations to the embodiments disclosed readily suggest themselves to those skilled in the art upon reading and understanding the detailed description of the invention. It is intended to include all such modifications and alterations in-so-far as they come within the scope of the present invention.

We claim:

1. A modular-detachable welding wire cartridge for use in a wire feeder arrangement, said welding wire cartridge including a drive housing designed to be detachably connectable to the wire feeder arrangement, a wire contact arrangement designed to controllably feed welding wire through said wire feed drive, and a spool of welding wire, at least a majority of said spool of welding contained in said cartridge housing.

2. The welding wire cartridge as defined in claim 1, wherein said wire contact arrangement includes at least one drive roller.

3. The welding wire cartridge as defined in claim 1, including a gear arrangement to interconnect to said wire contact arrangement.

4. The welding wire cartridge as defined in claim 2, including a gear arrangement to interconnect to said wire contact arrangement.

5. The welding wire cartridge as defined in claim 1, including a wire guide designed to at least partially guide said welding wire from said wire contact arrangement to an exterior of said cartridge housing.

6. The welding wire cartridge as defined in claim 4, including a wire guide designed to at least partially guide said welding wire from said wire contact arrangement to an exterior of said cartridge housing.

7. The welding wire cartridge as defined in claim 1, wherein said cartridge housing includes a wire spool compartment designed to contain a spool of welding wire.

8. The welding wire cartridge as defined in claim 6, wherein said cartridge housing includes a wire spool compartment designed to contain a spool of welding wire.

9. The welding wire cartridge as defined in claim 1, including a wire spool tension arrangement designed to apply tension to said spool as such spool rotates in said cartridge housing.

10. The welding wire cartridge as defined in claim 8, including a wire spool tension arrangement designed to apply tension to said spool as such spool rotates in said cartridge housing.

11. The welding wire cartridge as defined in claim 1, including an identification arrangement at least partially on an exterior of said cartridge housing, said identification arrangement providing information about at least one component characteristic of said welding wire cartridge, said component characteristic including a characteristic selected from the group consisting of type of said welding wire to be used with said welding wire cartridge, diameter of said welding wire to be used in said welding wire cartridge, gear ratio of said gear arrangement in said cartridge housing, wire tension associated with said wire contact arrangement, spool break tension, recommended welding wire feed speed, amount of said welding wire remaining on said wire spool, model information about said welding wire cartridge, parts information regarding said welding wire cartridge, information about the proper welding unit, said welding wire cartridge can be used with, voltage information for a welding power wave, current information for a welding power wave, welding wire polarity information for a welding power wave, shielding gas information, or combinations thereof.

12. The welding wire cartridge as defined in claim 10, including an identification arrangement at least partially on an exterior of said cartridge housing, said identification arrangement providing information about at least one component characteristic of said welding wire cartridge, said component characteristic including a characteristic selected from the group consisting of type of said welding wire to be used with said welding wire cartridge, diameter of said welding wire to be used in said welding wire cartridge, gear ratio of said gear arrangement in said cartridge housing, wire tension associated with said wire contact arrangement, spool break tension, recommended welding wire feed speed, amount of said welding wire remaining on said wire spool, model information about said welding wire cartridge, parts information regarding said welding wire cartridge, information about the proper welding unit said welding wire cartridge can be used with, voltage information for a welding power wave, current information for a welding power wave, welding wire polarity information for a welding power wave, shielding gas information, or combinations thereof.

13. The welding wire cartridge as defined in claim 1, including a control interface that provides information between said welding wire cartridge and said welding system.

14. The welding wire cartridge as defined in claim 12, including a control interface that provides information between said welding wire cartridge and said welding system.

15. The welding wire cartridge as defined in claim 1, wherein an exterior of said cartridge housing includes a color coding used to identify at least one characteristic of said welding wire cartridge.

16. The welding wire cartridge as defined in claim 12, wherein an exterior of said cartridge housing includes a color coding used to identify at least one characteristic of said welding wire cartridge.

17. A method of supplying welding wire to a welding system comprising:
a) providing a welding wire feed system, said welding wire feed system selected from the group consisting of a welder wire feeder designed to push welding wire through a welding cable, a gun wire feeder designed to be integrated with a welding gun, or combinations thereof;
b) providing a modular-detachable welding wire cartridge for use in said welding wire feed system, said welding wire cartridge including a cartridge housing designed to be detachably connectable to the welding wire feed system, a wire contact arrangement designed to controllably feed welding wire through said welding wire cartridge, and a spool of welding wire, at least a majority of said spool of welding contained in said cartridge housing; and,
c) detachably connecting said modular-detachable welding wire cartridge to said welding wire feed system.

18. The method as defined in claim 17, wherein said wire contact arrangement includes at least one drive roller.

19. The method as defined in claim 17, including a gear arrangement interconnected to said wire contact arrangement.

20. The method as defined in claim 18, including a gear arrangement interconnected to said wire contact arrangement.

21. The method as defined in claim 17, including a wire guide designed to at least partially guide said welding wire from said wire contact arrangement to an exterior of said cartridge housing.

22. The method as defined in claim 20, including a wire guide designed to at least partially guide said welding wire from said wire contact arrangement to an exterior of said cartridge housing.

23. The method as defined in claim 17, wherein said cartridge housing includes a wire spool compartment designed to contain a spool of welding wire.

24. The method as defined in claim 22, wherein said cartridge housing includes a wire spool compartment designed to contain a spool of welding wire.

25. The method as defined in claim 17, including a wire spool tension arrangement designed to apply tension to said spool as such spool rotates in said cartridge housing.

26. The method as defined in claim 24, including a wire spool tension arrangement designed to apply tension to said spool as such spool rotates in said cartridge housing.

27. The method as defined in claim 17, including the step of identifying at least one component characteristic of said welding wire cartridge by use of an identification arrangement positioned at least partially on an exterior of said cartridge housing, said component characteristic including characteristic selected from the group consisting of type of said welding wire to be used with said welding wire cartridge, diameter of said welding wire to be used in said welding wire cartridge, gear ratio of said gear arrangement in said cartridge housing, wire tension associated with said wire contact arrangement, spool break tension, recommended welding wire feed speed, amount of said welding wire remaining on said wire spool, model information about said welding wire cartridge, parts information regarding said welding wire cartridge, information about the proper welding unit said welding wire cartridge can be used with, voltage information for a welding power wave, current information for a welding power wave, welding wire polarity information for a welding power wave, shielding gas information, or combinations thereof.

28. The method as defined in claim 26, including the step of identifying at least one component characteristic of said welding wire cartridge by use of an identification arrangement positioned at least partially on an exterior of said cartridge housing, said component characteristic including characteristic selected from the group consisting of type of said welding wire to be used with said welding wire cartridge, diameter of said welding wire to be used in said welding wire cartridge, gear ratio of said gear arrangement in said cartridge housing, wire tension associated with said wire contact arrangement, spool break tension, recommended welding wire feed speed, amount of said welding wire remaining on said wire spool, model information about said welding wire cartridge, parts information regarding said welding wire cartridge, information about the proper welding unit said welding wire cartridge can be used with, voltage information for a welding power wave, current information for a welding power wave, welding wire polarity information for a welding power wave, shielding gas information, or combinations thereof.

29. The method as defined in claim 17, including the step of providing information between said welding wire cartridge and said welding system.

30. The method as defined in claim 28, including the step of providing information between said welding wire cartridge and said welding system.

31. The method as defined in claim 17, wherein an exterior of said cartridge housing includes a color coding to identify at least one characteristic of said welding wire cartridge.

32. The method as defined in claim 30, wherein an exterior of said cartridge housing includes a color coding to identify at least one characteristic of said welding wire cartridge.
